(19) United States
(12) Patent Application Publication
(10) Pub. No.: US 2026/0303145 A1
(43) Pub. Date: Oct. 1, 2026

(54) Scheduling Beam-Hopping of a Satellite Network

(71) Applicant: Skylo Technologies, Inc., Mountain View, CA (US)

(72) Inventors: Soham Dhiren Desai, Palo Alto, CA (US); Meghna Agrawal, Cupertino, CA (US); Andrew Nuttall, Mountain View, CA (US); ASHRITH SULANAYAKANAHALLI RAVINDRA PRAKASH, Espoo (FI); Narges Gholipoor Shahraki, Espoo (FI)

(73) Assignee: Skylo Technologies, Inc., Mountain View, CA (US)

(21) Appl. No.: 19/540,640

(22) Filed: Feb. 14, 2026

Related U.S. Application Data
(60) Provisional application No. 63/820,774, filed on Jun. 10, 2025.
(60) Provisional application No. 63/779,130, filed on Mar. 27, 2025.

(51) Int. Cl. H04B 1/69; H04B 7/0408; H04B 7/08; H04B 7/204; H04L 5/00; H04W 72/044; H04W 72/0446; H04W 72/0453

(52) U.S. Cl. CPC H04B 1/69; H04B 7/0408; H04B 7/0802; H04B 7/2041; H04L 5/0023; H04W 72/0446; H04W 72/0453; H04W 72/046

(57) ABSTRACT

Apparatuses, methods, and systems for scheduling beam-hopping of a satellite network are disclosed. One method includes determining a macro hopping schedule, wherein the macro hopping schedule includes at least frequency and time slots that control frequency and time allocations for one or more beams of satellites of the satellite network directed to the plurality of cells, determining a micro hopping schedule, wherein the determination of the micro hopping schedule is dependent on the real time traffic demand, dynamically adjusting, by the satellite base station, frequency and time allocations of the macro hopping schedule and the micro hopping schedule for high traffic and low traffic beams comprising reallocating underutilized time slots of the micro hopping schedules from the lower traffic beams to the higher traffic beams, wherein the lower traffic beams have a lower demand for wireless data traffic than high traffic beams.

### RELATED PATENT APPLICATIONS

This patent application claims the benefit of US Provisional Patent Application Serial No. 63/820,774, filed Jun. 10, 2025, and US Provisional Patent Application Serial No. 63/779,130, filed Mar. 27, 2025, which are herein incorporated by reference.

### FIELD OF THE DESCRIBED EMBODIMENTS

The described embodiments relate generally to wireless communications. More particularly, the described embodiments relate to systems, methods, and apparatuses for scheduling beam-hopping of a satellite network.

### Background

Low Earth Orbit (LEO) satellites typically operate at altitudes ranging from approximately 600 to 1,200 kilometers above the Earth's surface. These satellites are deployed in large constellations, distributed across multiple orbital planes, to provide continuous and scalable coverage tailored to the geographic distribution of users and the dynamic traffic requirements of the network.

Due to their low altitude and rapid orbital velocity, each LEO satellite can only serve a specific geographic area for a limited period of time before it moves out of range. To manage this transient coverage, satellites are equipped with either a single wide-area beam or multiple narrow beams, both of which can be electronically steered to follow user locations on the ground. In the context of Earth-fixed cell design, a traditional and widely used method in LEO networks, the Earth's surface is divided into fixed geographical regions (cells) that require continuous service. This is achieved by base stations that remain focused on the same regions and retain the same Physical Cell Identifier (PCI), even as satellites move in their orbits. These geographical areas are referred to as cells.

These fixed cells are sequentially served by different satellites as they pass overhead. The handover from one satellite to the next is carefully orchestrated based on orbital timing, traffic demand, and overall network strategy.

While wide beams are capable of being steered to track Earth-fixed cells, they typically provide lower spatial resolution and less efficient frequency reuse. Narrow beams, by contrast, offer several key advantages. They allow for higher antenna gain, improved link budget performance, and more efficient spectral reuse due to their tighter coverage footprint. These benefits enable better signal quality and support higher user densities, making narrow beam configurations particularly suitable for modern LEO systems aiming to deliver high-throughput and low-latency connectivity. Consequently, narrow beam architectures are increasingly preferred in LEO networks that implement Earth-fixed cell designs, where precise beam steering and seamless satellite handovers are essential to maintaining consistent service quality.

It is desirable to have methods, apparatuses, and systems for scheduling beam-hopping of a satellite network.

### Summary

An embodiment includes a method for controlling beam-hopping of a satellite base station of a satellite network across a plurality of fixed geographical cells. The method includes determining, by the satellite network, a macro hopping schedule, wherein the macro hopping schedule includes at least frequency and time slots that control frequency and time allocations for one or more beams of satellites of the satellite network directed to the plurality of cells (for an embodiment, the plurality of cell includes fixed geographical cells), determining, by the satellite base station, a micro hopping schedule, wherein timeslots of the micro hopping schedule have a shorter time duration (for example, a factor of 10 shorter)than the timeslots of the macro hopping schedule, wherein the determination of the micro hopping schedule is dependent on the real time traffic demand, dynamically adjusting, by the satellite base station, frequency and time allocations of the macro hopping schedule and the micro hopping schedule for high traffic and low traffic beams comprising reallocating underutilized time slots of the micro hopping schedules from the lower traffic beams to the higher traffic beams, wherein the lower traffic beams have a lower demand for wireless data traffic than high traffic beams, wirelessly communicating, by the satellite base station, with wireless devices located within cell areas of the plurality of cells according to the dynamically adjusted frequency and time allocations of the macro hopping schedule and the micro hopping schedule.

Another embodiment includes a satellite network. For an embodiment, the satellite network includes a master scheduler configured to determine a macro hopping schedule, wherein the macro hopping schedule includes at least frequency and time slots that control frequency and time allocations for one or more beams of satellites of the satellite network directed to the plurality of cells, and determine a micro hopping schedule, wherein timeslots of the micro hopping schedule have a shorter time duration than the timeslots of the macro hopping schedule, wherein the determination of the micro hopping schedule is dependent on the real time traffic demand, and a satellite base station configured to dynamically adjust frequency and time allocations of the macro hopping schedule and the micro hopping schedule for high traffic and low traffic beams comprising reallocating underutilized time slots of the micro hopping schedules from the lower traffic beams to the higher traffic beams, wherein the lower traffic beams have a lower demand for wireless data traffic than high traffic beams, and wirelessly communicate with wireless devices located within cell areas of the plurality of cells according to the dynamically adjusted frequency and time allocations of the macro hopping schedule and the micro hopping schedule.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows a satellite in motion and beam patterns of the satellite, according to an embodiment.

FIGS. 2A, 2B show a satellite in motion that provides wireless coverage of a plurality of fixed geographic cells, wherein a base station of the satellite network is either located on earth, or collocated with the satellite, according to an embodiment.

FIG. 3 is a flow chart that includes steps of a method of scheduling beam-hopping of a satellite network, according to an embodiment.

FIG. 4 shows a macro hopping schedule and a micro hopping schedule of wireless communication with each of the plurality of cells, according to an embodiment.

FIG. 5 is a table of fields required for beam hopping, according to an embodiment.

FIG. 6 is a block diagram that depicts multiple satellite base stations requesting macro hopping and micro hopping schedules from a master scheduler of a satellite network, according to an embodiment.

FIG. 7 is a block diagram of a satellite base station requesting and receiving a macro hopping schedule and a micro hopping schedule from a master scheduler, according to an embodiment.

### DETAILED DESCRIPTION

The embodiments described include methods, apparatuses, and systems for scheduling beam-hopping of a satellite network. For an embodiment, a macro hopping schedule and a micro hopping schedule are generated for beam-formed wireless communication between wireless devices and a satellite base station. For an embodiment, time and/or frequency allocations of the micro hopping schedule are reallocated to beams that have a greater demand from beams that have less demand.

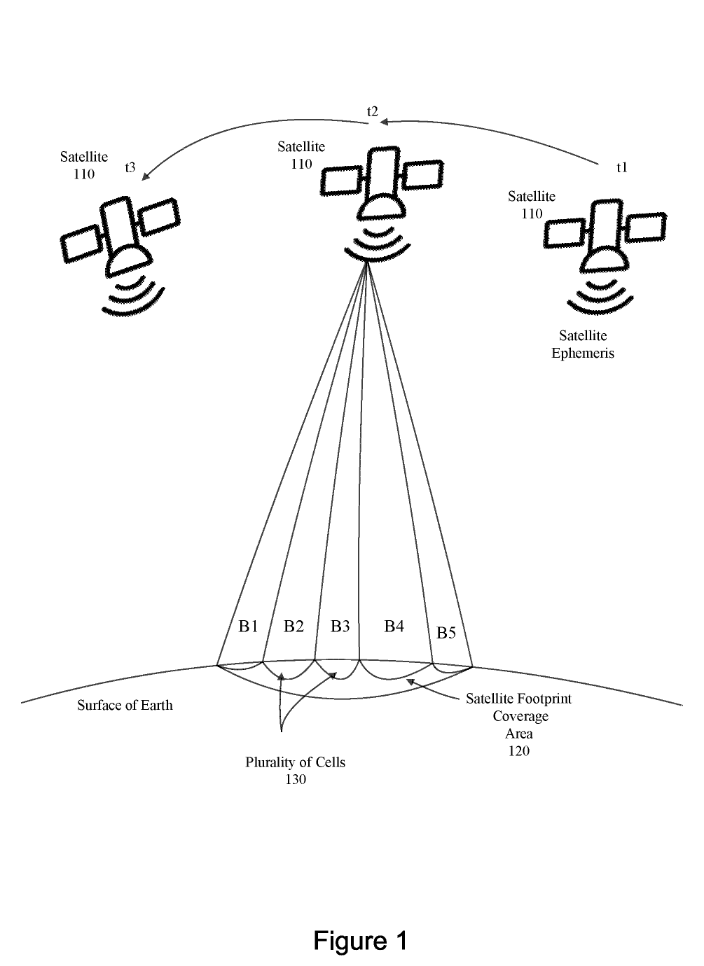

FIG. 1 shows a satellite 110 in motion and beam patterns B1, B2, B3, B4, B5 of the satellite 110, according to an embodiment. For an embodiment, the satellite is a Low Earth Orbit (LEO) satellite. Due to their low altitude and rapid orbital velocity, each LEO satellite can only serve a specific geographic area for a limited period of time before it moves out of range. To manage this transient coverage, satellites are equipped with either a single wide-area beam or multiple narrow beams, both of which can be electronically steered to follow user locations on the ground.

In order to provide coverage of a particular location (such as, satellite footprint coverage area 120) on the surface of the earth, beams from the satellite 110 (at other subsequent satellites in time) must be managed (scheduled) over time. As shown, the different beams B1, B2, B3, B4, B5 provide wireless satellite coverage over a plurality of cells formed by each of the different beams B1, B2, B3, B4, B5. For an embodiment, a wide beam covers the entire area of the cells and the different beams B1, B2, B3, B4, B5 are narrow beams that each provide coverage within a corresponding cell within the entire coverage area of the cells.

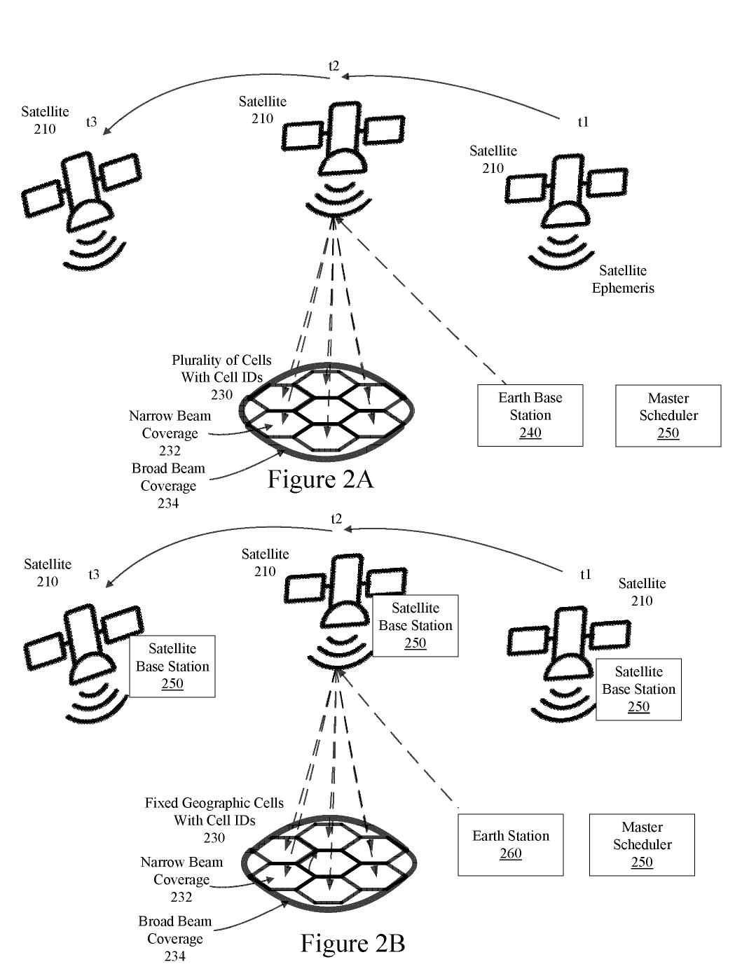

FIGS. 2A, 2B show a satellite 210 in motion that provides wireless coverage of a plurality cells, wherein a base station of the satellite network is either located on earth, or collocated with the satellite, according to an embodiment. The base station 240 of FIG. 2A is an earth base station 240 that wirelessly communicates with wireless devices within the broadband coverage area 234. As the satellites (including satellite 210) pass over the broadband coverage area 234, the earth base station transitions from communicating with the wireless devices within the broadband coverage area 234 through the different satellites as the satellites pass over the broadband coverage area 234. The base station 240 is interfaced with a master scheduler 250 of the satellite network that provides schedules of frequency and time in which the base station wirelessly communicates with different wireless devices within each cell of the broad beam coverage area, wherein the area of each cell is defined by narrow beam coverage of narrow beams from the base station 240 through the satellite 210.

The base station 250 of FIG. 2B is a satellite-based base station that transitions from being located in a continually changing satellite locations as the satellites pass over the broadband coverage area 234. The plurality of cells of the fixed geographical location as identified by the broadband coverage area 234 are designated or identified with a cell ID 230. Accordingly, the base station is a virtual device that is defined by the cell ID of the coverage area 234 the base station 250 provides wireless coverage. The base station 250 is also interfaced with the master scheduler, but through an earth station 260 located on the surface of the earth.

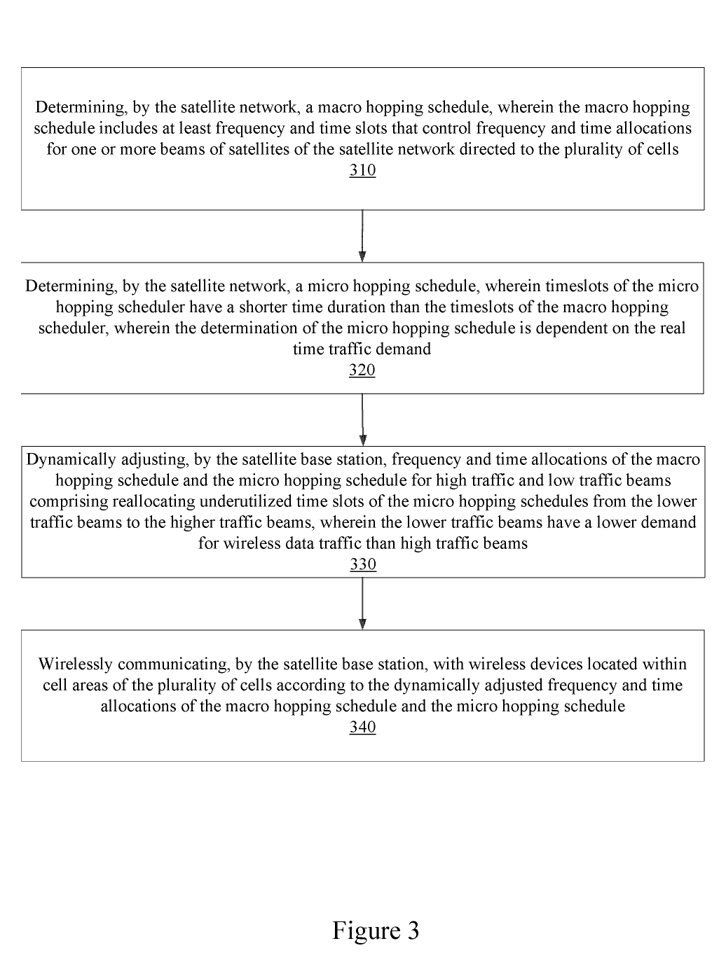

FIG. 3 is a flow chart that includes steps of a method of scheduling beam-hopping of a satellite network, according to an embodiment. A first step 310 includes determining, by the satellite network, a macro hopping schedule, wherein the macro hopping schedule includes at least frequency and time slots that control frequency and time allocations for one or more beams of satellites of the satellite network directed to the plurality of cells (for an embodiment, the plurality of cells include a plurality of fixed geographical cells) cells. A second step 320 includes determining, by the satellite network, a micro hopping schedule, wherein timeslots of the micro hopping schedule have a shorter time duration than the timeslots of the macro hopping schedule (for example, a factor of 10 shorter), wherein the determination of the micro hopping schedule is dependent on the real time traffic demand. A third step 330 includes dynamically adjusting, by the satellite base station, frequency and time allocations of the macro hopping schedule and the micro hopping schedule for high traffic and low traffic beams comprising reallocating underutilized time slots of the micro hopping schedules from the lower traffic beams to the higher traffic beams, wherein the lower traffic beams have a lower demand for wireless data traffic than high traffic beams. A fourth step 340 includes wirelessly communicating, by the satellite base station, with wireless devices located within cell areas of the plurality of cells according to the dynamically adjusted frequency and time allocations of the macro hopping schedule and the micro hopping schedule.

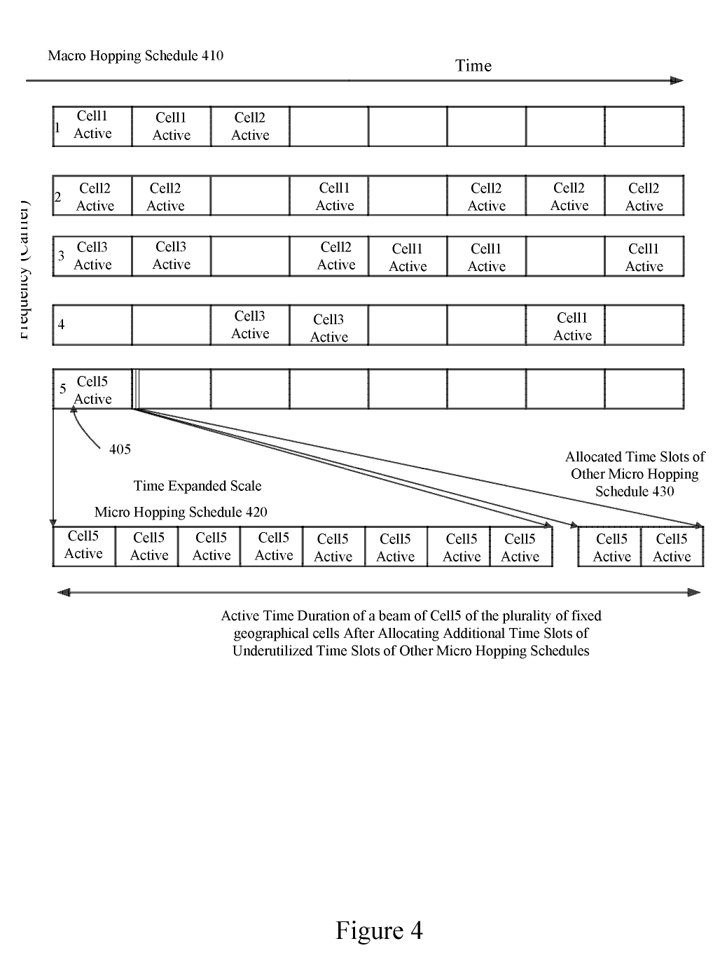

FIG. 4 shows a macro hopping schedule 410 and a micro hopping schedule 420 of wireless communication with each of the plurality of cells, according to an embodiment. By example, the macro hopping schedule 410 includes 5 frames, wherein each frame has a different carrier frequency. Further, by example, each frame includes 8 time slots. The macro schedule 410 includes assignments of a one of the plurality of beams correlated with a one of the plurality of cells. Each of the frequency and time allocations are assigned/allocated for beams of satellites of the satellite network directed to the plurality of cells. For example, as shown, a Cell1 of the plurality of cells is assigned to the first time slot of the first carrier frequency (1), and a Cell2 of the plurality of cells is assigned the first time slot of the second carrier frequency (2).

By example, the micro hopping schedule 420 includes 8 timeslots. As shown, the micro hopping schedule 420 is time expanded for illustrative purposes. For an embodiment, the micro hopping schedule 420 falls within the time slot 405 of the macro schedule of the fifth carrier frequency (5) of the macro schedule 410.

As shown, a time duration of the time slot 405 of the macro schedule 410 is expanded (increased) by appending time slots 430 of a micro hopping schedule of another time slot of another macro hopping schedule. The time expansion or enhanced (increased) time allocation provides the cell5 with greater time/frequency spectrum resources. As previously described, for an embodiment, frequency and time allocations of the macro hopping schedule and the micro hopping schedule are dynamically adjusted for high traffic and low traffic beams including reallocating underutilized time slots of the micro hopping schedules from the lower traffic beams to the higher traffic beams, wherein the lower traffic beams have a lower demand for wireless data traffic than high traffic beams. For an embodiment, the allocated times for each of the different beams corresponding with the different cells is referred to as a coverage pulsed.

For an embodiment, underutilized time slots of the other micro schedules are reallocated to fully utilized time slots of the micro schedules. For an embodiment, the unused/underutilized time slots of the other micro hopping schedules include portions of time slots of macro hopping schedules for other satellite base stations of other fixed geographical cells of other beams that are active (true for non-active too) at a corresponding time as the beam of the first cell. For an embodiment, dynamically adjusting the allocated time (active time duration) of a first serving beam includes assigning a service interval defined by a dynamic multiplication factor 'a' to the plurality fixed geographical cells, such that a cell of the plurality fixed geographical cells is served every aX/Y time slots, where X is the total number of cells and Y is the maximum number of simultaneous narrow beams the satellite supports, thereby reallocating unused beam resources to high-demand cells, wherein X is fixed, Y is fixed, and “a” is selected based on unused (or underutilized) time slots of other micro hopping schedules of other concurrently active beams to a first serving beam of a first cell.

For an embodiment, the macro hopping schedules for each of the beams are predefined based on a broadcast signal periodicity, wherein the broadcast signal periodicity is a period of time between transmission of broadcast signal by the satellite base station.For an embodiment, broadcast signals are periodically transmitted to wireless devices located within an area wirelessly covered by the plurality of cells. The broadcasts provide satellite network information to the wireless devices. For an embodiment, a predefined macro hopping schedule for each of the plurality of cells and corresponding beams is determined based on fixed 3GPP (3^{rd} generation partnership project) based on broadcast signal periodicity.

As previously described, at least some embodiments include dynamically adjusting time and frequency allocated to different beams comprising reallocating time slots of micro hopping schedules from beams that are underutilized to beams that are more utilized.

As shown in FIGS. 2A and 2B, for an embodiment, the satellite base station is defined by cell identifiers of the plurality of geographical cells over a fixed geographical area, wherein the satellite base station is at a fixed location for an earth satellite base station, and wherein the satellite base station changes satellite locations over time for a satellite based base station. That is, for an embodiment, the satellite network includes virtual base stations that are defined by the cell identifier of the plurality of fixed geographic location cells. For base stations collocated with the satellites of the satellite network, the location of the base station for the plurality of cells changes over time as the satellite serving the plurality of cells changes over time. However, for an earth located base station, the location of the base station may be fixed in location as the satellite serving the plurality of cells changes over time. Again, the notion of a base station is determined by an identifier associated with the plurality of cells.

For an embodiment, as shown in FIGS. 2A and 2B, each fixed geographical cell of the plurality of fixed geographical cells has a plurality of neighboring cells of the plurality of fixed geographical cells.

For an embodiment, as shown in FIGS. 2A and 2B, the satellite base station receives the macro hopping schedule and the micro hopping schedule from a master scheduler 250, wherein the master schedule 250 is located at one or more of multiple locations of the satellite network.

For an embodiment, a time duration of the time slots of the macro hopping schedule is long enough that wireless devices receiving beams do not go into a radio link failure state when beams hop from one cell to another cell. For an embodiment, the time duration of the time slots of the macro hopping schedule is selected based on message periodicity and repetition of broadcast messages sent to wireless devices located within the plurality of cells. For an embodiment, the broadcast message includes information blocks, such as, a master information blocks (MIBs) or system information blocks (SIBs). For an embodiment, the MIBs and SIBs are crucial broadcast messages in cellular networks (like LTE (long term evolution) and 5G) that carry essential network configuration data from the base station (eNodeB/gNB/satellite base station) to wireless devices (UEs), allowing the wireless devices to access the cell, connect, and manage resources, with the MIB containing the most critical info for initial access (bandwidth, SIB schedules) and SIBs providing detailed parameters for cell reselection, mobility, and more.

For an embodiment, the time duration of the time slots of the macro hopping schedule is more than a radio link failure (RLF) detection timer (T310) configured on a wireless device that communicates with the satellite network. The detection time T310 is a timer started by the UE (wireless device) upon detecting consecutive "out-of-sync" indications for the PCell (Primary Cell) from lower layers (physical layer). The T310 timer supervises the time the UE (wireless device) waits for conditions to improve or a recovery response from the network before declaring radio link failure. When the UE (wireless device) is unable to decode control channels, for example, the physical downing control channel, a timer starts running and this timer is known as T310. This time duration ensures that the wireless device in the coverage area of a beam does not go to the radio link failure state when the satellite beam hops to other cells.

For an embodiment, the wireless devices synchronize with base station broadcast messages (fixed periodicity). For an embodiment, the base station broadcast signal includes a Primary Synchronization signal (PSS), or a Secondary Synchronization signal (SSS). For an embodiment, the PSS and the SSS provide timing synchronization and cell ID about the broadcasting base station to wireless devices located within an area defined by the plurality of cells. An exemplary PSS is broadcast every 10 milliseconds, which receiving wireless devices can utilize to synchronize their internal clocks. The broadcast signals are very robust and allow the receiving wireless device to determine the channel conditions (channel state information), and subsequently decode other messages based on the channel state information. For an embodiment, the PSS and SSS together provide the Cell ID of the plurality of cells. For an embodiment, once synchronized, the wireless devices can utilize the internal clocks to maintain frequency and timing without receiving synchronization information for a period of time. However, over time the clock will eventually drift and again need to receive the broadcast signals for resynchronization. For an embodiment, missing more than a number X of the broadcast signals causes a wireless device to suffer a radio link failure (RLF). For an embodiment, the number X is determined or set by a T310 timer. For an embodiment, the periodicity of the broadcast signals is specified by the LTE, 5G NR 3GPP standards.

As previously described, for an embodiment, the micro hopping schedule is determined based at least on real time traffic demand. That is, a traffic demand by the wireless devices location within the coverage area of the satellite base station. For an embodiment, the micro hopping schedule is determined further based on a message priority of messages being communicated to wireless devices located within the plurality of fixed geographical cells. That is, higher priority messages can get more time allocation and also priority allocation of resource/time slots.

At least some embodiments include determining the real-time traffic demand based on buffer status reports. For an embodiment, each user (wireless device) reports how much data the wireless device needs to send to the network which may be included within a buffer status report (BSR). For an embodiment, if a user has a lot of data to send, the master scheduler will allocate more narrow beam resources for that user (wireless device) in the form of additional micro hopping time and/or frequency slots which are appended to time and/or frequency slots of the macro hopping schedule.

For an embodiment, an allocated active time duration allocated to each beam is initially set by the duration of the timeslots of the macro hopping schedule and subsequently adjusted by underutilized timeslots of the micro hopping schedules of other beams. This was previously shown in FIG. 4, wherein the allocated active time duration of a beam includes the allocated macro hopping time slot(s) along with the reallocated micro hopping time slots.

At least some embodiments further include determining by the satellite master scheduler a history function that represents deferred messages for all wireless devices and all base stations serving all the cells in a particular area, wherein the particular area is defined by the plurality of geographical cells, and reallocating underutilized time slots of the micro hopping schedules from the lower traffic beams to the higher traffic beams based on the history function. For an embodiment, time and/or frequency allocated to one or more of the beams are adjusted based on the history function to mitigate under allocation or overallocation to one or more of the beams.

For an embodiment, the area (particular area) covered by the plurality of cells includes a set of fixed geographical cells which are covered by 1 set of satellites and or earth station as defined by ease of scheduling macro and micro hopping schedule, regulatory requirements and time constraints. An embodiment includes utilizing the history function within the Master Scheduler to track a delay history of previously deferred messages for other cells, and based on the delay history, elevating the service priority of the other cell relative to other of the other cells in a subsequent micro hopping scheduling cycle.

For an embodiment, previously deferred messages tracked by the history function include lower-priority traffic, and wherein elevating a service priority of the other cells prevents the lower-priority traffic from being indefinitely postponed. As previously described, high-priority traffic is data traffic that has a greater demand than the lower-priority traffic and can be identified as being greater than a predetermined threshold. For an embodiment, the predetermined threshold may be adaptive based on a message coming from a wireless device that has opted for a higher message service tier, a message coming from a wireless device that has indicated this session as an emergency (SOS) session.

At least some embodiments further include determining a real-time traffic demand based on receiving a traffic indication (buffer status report (BSR)) with a predetermined set of Random Access Preamble (Msg1) transmission from a wireless device within a coverage area of at least one of the plurality of beams, wherein the traffic indication is included within a Msg1 provides immediate demand knowledge to a Master Scheduler by avoiding a delay of at least two Round-Trip Times (RTTs) that would be incurred if the traffic indication were transmitted via an uplink scheduled transmission (Msg3).

For the described embodiments, a message1 (Msg1) includes preamble transmission in which a wireless device selects a random-access preamble from a set of predefined preambles. The wireless device also selects a random sequence number for the preamble. After choosing the preamble and sequence number for the preamble. After selecting the preamble and the sequence number, the wireless device transmits the preamble on the PRACH. This indicates to the satellite network that a wireless device wants to communicate.

For the described embodiments, a message2 (Msg2) includes a random access response, and upon receiving the Msg1, the gNB/eNB (satellite base station) sends a response called Msg2. The Msg2 includes several critical pieces of information, such as the Time Advance (TA) command for timing adjustment, the RAPID (Random Access Preamble ID) matching the preamble sent by the wireless device, and an initial uplink grant for the wireless device. The satellite base station also assigns a temporary identifier called RA-RNTI (Random Access Radio Network Temporary Identifier) to the wireless device.

For an embodiment, using an initial uplink grant provided in Msg2, the wireless device transmits a message3 (Msg3) on a PUSCH (Physical Uplink Shared Channel), wherein the Msg3 is a PUSCH which may carry a certain RRC message(for example, RrcRequest) or just be pure PHY data.

For an embodiment, the wireless device uses a fixed set of preambles that provides information regarding how much data the wireless device has to send which provides the satellite network with the real time traffic demand of the wireless device. Further, this information provides the satellite network with a message priority of the data of the wireless device. For an embodiment, the information is included by the BSR and preamble selected. As described, for an embodiment, the master scheduler determines the micro hopping schedule for each of the beams based on this information. For an embodiment, the data traffic demand and/or priority of the data traffic is included within a MSG1, and for an embodiment, within a Buffer Status Report indexing in the MSG1.

At least some embodiments further include employing an adaptive repetition function o dynamically adjust a repetition countof critical system broadcasts, including Master Information Block (MIB) and System Information Block (SIBs transmissions, based on channel utilization, thereby adjusting available resources for user data transmission by adjusting (increase/decrease) the broadcast duty cycle, wherein the broadcast duty cycle defines a relation between a time where the broadcast is on/active versus all other available time that the broadcast can be transmitted. For an embodiment, the broadcast messages are always broadcast at the same rate. For an embodiment, a repetition count indicates how many times the broadcast message is repeated in each broadcast interval. For an embodiment, a broadcast macro hopping schedule includes time and frequency slots of the macro hopping schedule allocated to broadcast signals. The described embodiments for adjusting the repetition count of the broadcasts based on channel utilization operate to reduce a broadcast time allocation for a beam that has a low channel utilizations, and use the channel resource for other beams for user (wireless device) data traffic for the other beams which have a high (higher) channel utilization and user data demand.

For an embodiment, executing the macro hopping schedule includes configuring a coverage pulse (activation time per the time slots of the macro and micro hopping schedules) to be long enough for the wireless device to obtain its RRC connection. Further, for an embodiment, the macro hopping cycle length is set to be shorter than a modified T310 timer setting,

For an embodiment, the one or more beams of satellites include narrow beams and wide beams and further include selecting a narrow beam or a wide beam for wireless communication with wireless devices within a coverage area of the plurality of cells based on a type of messaging being communication with the wireless devices. For an embodiment, the one or more beams include wide beams or narrow beams, wherein a selection of beam size is based on the type of message being transmitted by the satellite base station. For example, a wide beam may be utilized for PSS (primary synchronization signals) or SSS (secondary synchronization signals) and narrow band beams may be utilized for unicast data traffic.

For an embodiment, the satellite network (for an embodiment, a beam orchestrator of the satellite network) is configured to opportunistically activate wider beams to transmit broadcast information, such as PSS/SSS (Primary and Secondary Synchronization Signals), ensuring that essential system messages can be sent over a large area).

For an embodiment, the lower traffic beams and the high traffic beams are determined based on PRACH (Physical Random-Access Channel) (MSG1) traffic received in different beams. For an embodiment, the beam orchestrator (BO) is an entity (functional block) within the master scheduler of the satellite network which is responsible for dynamically adjusting the micro and macro hopping schedules. For an embodiment, the BO operates as a master control entity responsible for managing both UL (uplink from wireless devices to the satellite) and DL (downlink from the satellite to the wireless devices) resources of the satellite. For an embodiment, a role of the BO is to make real-time decisions that optimize the allocation and scheduling of these resources across the satellite’s footprint (as determined by the plurality of cells). The result of these decisions is a beam hopping strategy, which dynamically determines which cells are served and when as set by the macro and micro hopping schedules.

For an embodiment, BO is configured to dynamically define or reconfigure the number and size of cells within the satellite footprint based on network needs. For an embodiment, the BO is configured to opportunistically activate wider beams to transmit broadcast information, such as PSS/SSS (Primary and Secondary Synchronization Signals), ensuring that essential system information reaches all devices, even in lightly loaded or transitional coverage areas.

For an embodiment, rather than dynamically adjusting the activation duration (time allocation) of each cell, at least some embodiments include adjusting the bandwidth of each beam based on traffic demand. This approach involves classifying cell traffic demand into distinct groups, such as B groups, and assigning these groups to specific beams. Consequently, beams can be provisioned with different bandwidths depending on their respective traffic demands. This dynamic bandwidth allocation strategy optimizes resource utilization across the entire system.

For an embodiment, to enable efficient implementation of the beam hopping algorithm (macro and micro hopping schedulers), existing timers such as can be adjusted by the satellite base station and/or a wireless device. By configuring these timers appropriately, the wireless device can remain in an RRC connected state even of the wireless device loses synchronization during the waiting period between transmission opportunities. This approach provides the UE (wireless device) with sufficient time to regain synchronization without triggering a connection release. Additionally, the network can inform the UE (wireless device) of its designated time step for DL signal reception and UL signal transmission, ensuring reliable communication while maintaining connection stability. For the description here, the timer T310 is a timer started by the UE upon detecting consecutive "out-of-sync" indications for the Serving cell from lower layers (physical layer). It supervises the time the wireless device waits for conditions to improve or a recovery response from the network before declaring radio link failure. For the description here, the timer N310 is a configurable constant that specifies the number of consecutive "out-of-sync" indications the wireless device must receive from the lower layers (physical layer) before taking action (for example, starting T310).

For an embodiment, upon receiving N310 consecutive "out-of-sync" indications, the wireless device considers radio link failure to be in a degraded state and starts the T310 to monitor whether the situation recovers within the timer's duration. For an embodiment, the N3100 is a configurable constant that specifies the number of consecutive "in-sync" indications the wireless device must receive from the lower layers to consider the radio link as recovered. Upon receiving N311 consecutive "in-sync" indications while T310 is running, the wireless device stops T310. Further, the wireless deviceconsiders the radio link to have recovered and maintains the current RRC connection without additional signaling.

An embodiment includes buffer status reports (BSRs) for both UL and DL transmissions offers a more efficient and dynamic approach to resource scheduling. By leveraging BSR data, the scheduling process can be improved, particularly in scenarios whereusers (wireless devices) in different cells have varying data transmission needs. For example, if Cell A reports users with substantial UL data to transmit, while Cell B reports users with only small messages, more time steps may be needed to complete transmission of Cell A or more resources. Once Cell B has transmitted their smaller messages, they no longer need to be scheduled for the next round, allowing their allocated time to be reallocated to Cell A. This optimization is directly linked to the type of information sent in Msg1 or through a Scheduling Request (SR).

At least two potential embodiments for sending the BSRs include 1. via Msg1 or via Msg3. Sending the BSR via Msg1 allows for more precise and immediate resource scheduling, as it provides the eNB (satellite base station) with detailed information on the buffer status of each user for UL transmission. This enables better timer value configurations and more accurate scheduling decisions. However, sending the BSR via Msg3 introduces a delay of at least two Round-Trip Times (RTTs) before optimal scheduling can occur. Despite the delay, this method may still offer benefits depending on the specific use case and network configuration.

An embodiment includes two fields (firsts field, second field) as part of the Msg2 (Random Access Response) message: msg3-schedule-later and msg3-offset. These fields allow the satellite base station to instruct the wireless to defer the transmission of Msg3 in scenarios where the currently active beam is expected to become inactive shortly.

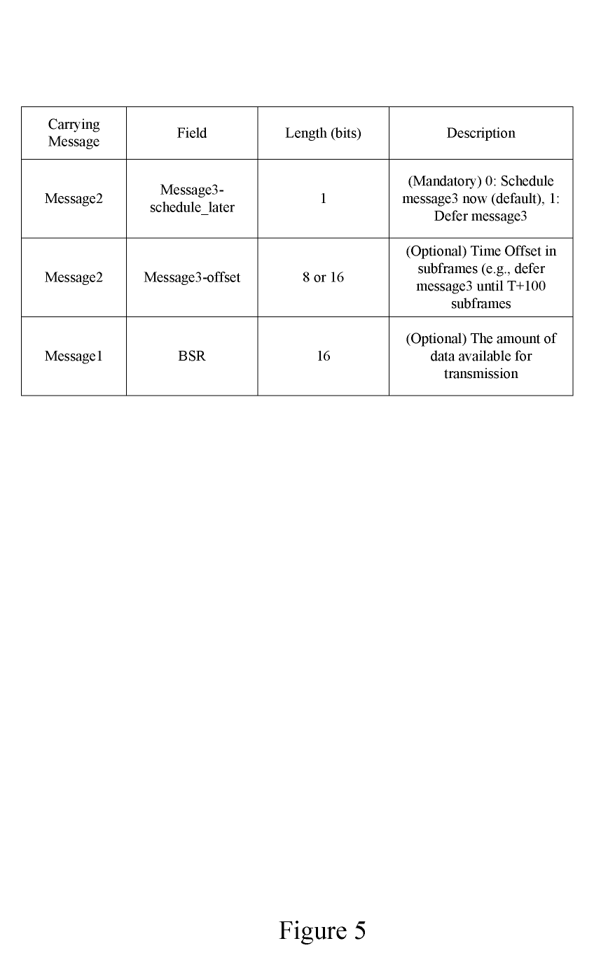

FIG. 5 is a table of fields required for beam hopping, according to an embodiment. The fields include a carrying message, a field, a length. The table further includes a description. This table indicates the new fields in messages Msg2 (RAR) and Msg1 (PRACH), including other fields, such as, Message3-scheduler-later which is a mandatory field that indicates that the Message3 needs to be deferred. The RAR also includes new fields like Message3-offset which indicates to the wireless device the time offset by which it needs to defer the Message3. Information within the message3 includes a buffer status report (BSR) indication which can be used to inform the network about the size of data in the buffer.

An embodiment further includes initiating a fast scan mode based on at least one of an initialization (initial startup) of the satellite base station, a periodic initiation (fast scan performed periodically), initiation fast scan initiated based on sensed conditions) based on sensing a level of traffic disparity. For an embodiment, the fast scan mode includes performing, by the satellite base station, beam hopping across an entire coverage area of the plurality of cells to detect and assess traffic activity in each cell of the plurality of cells; and cyclically activating, by the satellite base station, all beams of interest (beams of the plurality of cells) at regular intervals, enabling PRACH (Physical Random-Access Channel) opportunities for wireless devices located in every cell, wherein the fast scan mode serves as a discovery and monitoring phase to identify where active uplink requests or connection attempts are occurring. The fast scan mode is useful because it determines an initial micro hopping schedule or plan that is data traffic of the wireless devices within the plurality of cells dependent. Further, the fast scan mode operates to periodically provide a representation of changing data traffic demand across an entire coverage area of the plurality of cells which acts as a feedback loop to update the micro hopping schedule(s). Further, for an embodiment, the fast scan mode operates to provide feedback for generation of a broadcast macro hopping schedule (that is, a time and frequency slots of the macro hopping schedule allocated to broadcasts) since cells with low data traffic can be provided with reduced (lower) broadcast repetitions and accordingly the freed resources can be allocated to other beams of the plurality of cells. For an embodiment, broadcasts are broadcast according to a default broadcast duty cycle which is incorporated into the initial macro hopping schedule, which can be referred to as the broadcast macro hopping schedule, the broadcast macro hopping schedule includes the time and frequency slots of the macro hopping schedule allocated to broadcast signals.

An embodiment includes a beam orchestrator (BO) that provides intelligence in the beam hopping scheduling. For an embodiment, the beam orchestrator (BO) operates as a master control entity responsible for managing both UL (wireless communication from wireless devices to the satellite base station through the satellite) and DL (wireless communications from the satellite to the wireless devices through the satellite) resources on the satellite. Its primary role is to make real-time decisions that optimize the allocation and scheduling (macro and micro hopping schedules) of these resources across the satellite’s footprint (as defined or covered by the plurality of cells). The result of the decisions is a beam hopping strategy which dynamically determines which cells are served and when.

For an embodiment, in the fast scan mode the BO is configured to perform beam hopping across the entire coverage area to detect and assess traffic activity in each cell. It cyclically activates all beams of interest at regular intervals, enabling PRACH (Physical Random-Access Channel) opportunities for devices in every cell. For an embodiment, the fast scan mode serves as a discovery and monitoring phase to identify where active UL requests or connection attempts occur.

For an embodiment, once active cells with ongoing traffic are identified, the BO transitions to this mode. Here, it dynamically allocates more resources—specifically, longer active beam durations—to cells with higher traffic demands. Optionally, the BO reduces the frequency or duration of beam allocation to low-traffic or inactive cells. This approach optimizes capacity and minimizes unnecessary resource usage, a process often referred to as active beam duration extension.

For an embodiment, the BO further operates to improve the use of unutilized timeslots. If an active beam has unused time or capacity, those timeslots can be reallocated to extend the duration of other active beams where additional resources are needed, and vice versa. This dynamic redistribution enhances overall system efficiency.

At least some embodiments include dynamic optimization of active beam durations (time allocations) based on real-time traffic demand and wireless device density within each cell. This optimization enables flexible resource allocation; for instance, cells experiencing high traffic demands and wireless device densities will be allocated extended active time durations (allocations), while cells with minimal or no traffic can be temporarily deactivated. This adaptive approach ensures efficient resource utilization and dynamic optimization for each region.

For an embodiment, the BO is also configured to control the number of narrow beams active within the satellite footprint at any given time. Referring to the earlier example of 100 Earth-fixed cells and a satellite capable of supporting 20 simultaneous narrow beams: if a particular geographic region has low or no traffic demand, the BO may activate only 10 beams instead of the full 20. This conserves satellite power, frequency spectrum, and time resources.

At least some embodiments further include transmitting, by the satellite base station, to a wireless device, a Random Access Response (RAR) message comprising a first field indicating a transmission deferral requirement and a second field indicating a time offset, and deferring, by the wireless device, a Radio Resource Control (RRC) Connection Request message (Message3) when receiving instructions from the first field and the second field. For an embodiment, the first field and the second field are included as a part of a Message2 (Random Access Response) message: msg3-offset msg. As previously described, is a new mandatory field to indicate that the Message3 needs to be deferred. This RAR also includes new fields like Message3-offset which indicates to the wireless device the time offset by which it needs to defer the message3. For an embodiment, the first field and the second field allow the satellite base station to instruct a wireless device to defer transmission of a message 3 in situations in which a currently active beam is expected to become inactive shortly. For an embodiment, the deferring is based on a predicted inactivity period of the beam receiving the MSG1 wireless device, wherein the predicted inactivity period is determined from the macro hopping schedule.

An embodiment further includes broadcasting, by the satellite base station, system signaling, the system signaling including the macro hopping schedule, for a serving cell of the plurality of cells, and a macro hopping schedule of one or more neighboring cells, facilitating a mobility procedure for a wireless device based on the system signaling, wherein the mobility procedure includes informing a wireless device about information about beams of surrounding cells including when the beams of surrounding cells will be available and when a current beam of the serving cell will be unavailable, and allowing the wireless device to trigger and handover to another cell, and adapting grant requests for sending data based on the information.

For an embodiment, for each cell of the plurality of cells the satellite broadcasts neighbor cell information as part of the system signaling, which is crucial for supporting mobility procedures for wireless devices located within the plurality of cells. This information allows each wireless device to be aware of surrounding cells and prepare for seamless handovers or re-selection as the satellite beams hop or as the UE (wireless device) moves geographically.

For an embodiment, the neighbor cell information may include several key parameters including Ephemeris data of neighboring cells (satellites or beams) to predict their future positions, uplink and downlink frequencies used by neighboring cells, Active time windows indicating when each neighbor cell will be available for service, reference geographical locations or beam center coordinates of neighboring cells, and/or timing synchronization information to support rapid acquisition and handover. Further, for an embodiment, the satellite base station may also broadcast additional information related to MIB and broadcast messages scheduling providing wireless devices within information regarding intermittent transmission.

At least some wireless devices, particularly wireless devices equipped with GNSS (Global Navigation Satellite System) capabilities, can determine their own location with high accuracy. By combining this self-reported location with the neighbor cell information broadcasted by the satellite, the wireless device can make location-assisted mobility decisions. This includes proactively preparing for beam handovers, optimizing cell selection based on proximity and beam activity schedules, and even buffering or deferring uplink transmissions until the most suitable neighbor cell becomes active. A wireless device performs tracking Area Update once it moves to a new location with a different Physical Cell ID.

For an embodiment, for each beam of each of the plurality of cells, the satellite base station broadcasts neighbor cell information as part of the system signaling, which is crucial for supporting mobility procedures for wireless devices located within the plurality of cells. This information allows each wireless device to be aware of surrounding cells and prepare for seamless handovers or re-selection as the satellite beams hop or as the wireless device moves geographically. For an embodiment, the neighbor cell information may include several key parameters including Ephemeris data of neighboring cells (satellites or beams) to predict their future positions, uplink and downlink frequencies used by neighboring cells, Active time windows indicating when each neighbor cell will be available for service, reference geographical locations or beam center coordinates of neighboring cells, and/or timing synchronization information to support rapid acquisition and handover. Further, for an embodiment, the satellite base station may also broadcast additional information related to MIB and broadcast messages scheduling providing wireless devices within information regarding intermittent transmission.

An embodiment further includes configuring, on a wireless device, an extended radio link timer having a duration exceeding a standard T310 timer duration, monitoring, by the wireless device, a radio link between the satellite base station and the wireless device, and providing, by the wireless device, additional tolerance before triggering a Radio Link Failure (RLF) based on the extended radio link timer. For an embodiment, the extended radio link timer is a timer. Typically, the T310 timer is meant to work for a . For an embodiment, a timer, referred to as T310-Extended, is proposed. The T310-Extended timer serves as an enhancement to the traditional T310 timer, providing additional tolerance before triggering Radio Link Failure (RLF). This is particularly beneficial in scenarios where the wireless intermittently transitions between active and inactive cells due to beam hopping patterns or mobility across the satellite footprint. The normal T310 timer can be aligned with one of the cell’s inactive durations. For an embodiment, the additional tolerance corresponds to a duration in which a beam is directed away from the geographical cell of the wireless device according to the macro hopping schedule. For an embodiment, the scheduled beam-hopping introduces concurrency limits (for example, 30 total active channels) that ensures not all beams are active at once, further preventing an excessive duty cycle across multiple beams.

For an embodiment, a T310 timer is meant to work for a continuous coverage scenario and handle some packet losses due to intermittent poor channel conditions/obstructions. An embodiment includes an extended radio link that handles the discontinuous beam hopping which cannot be handled by the regular T310 timer.

For an embodiment, an alternate timer, referred to as T310-Extended, is configured to serve as an enhancement to the traditional T310 timer, providing additional tolerance before triggering Radio Link Failure (RLF). This is particularly beneficial in scenarios where the wireless device intermittently transitions between active and inactive cells due to beam hopping patterns or mobility across the satellite footprint (coverage area of the plurality of cells). For an embodiment, the normal T310 timer can be aligned with one cell’s inactive duration.

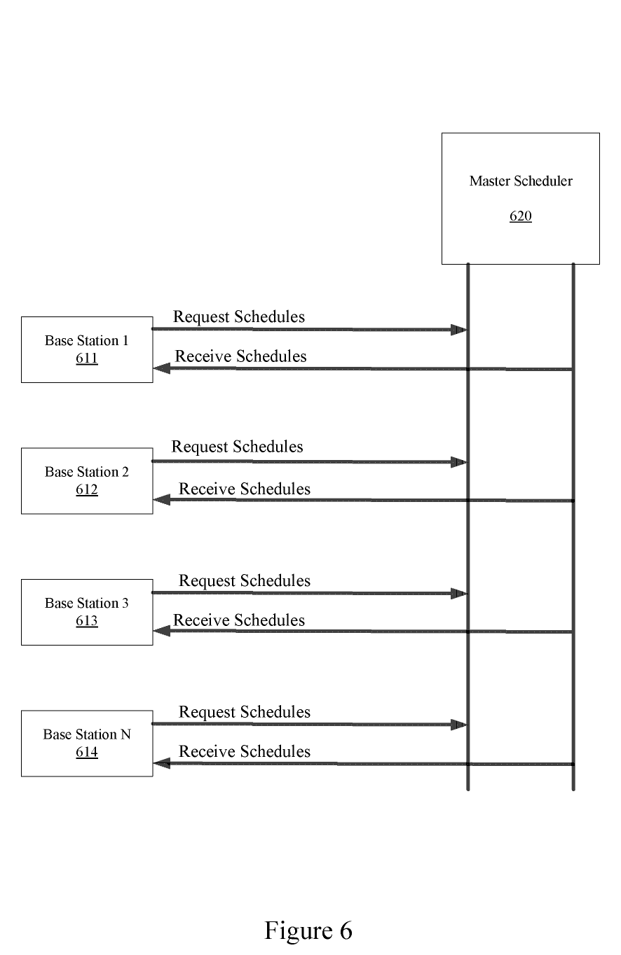

FIG. 6 is a block diagram that depicts multiple satellite base stations 611, 612, 613, 614 requesting macro hopping and micro hopping schedules from a master scheduler 620 of a satellite network, according to an embodiment. As shown, the multiple satellite base stations 611, 612, 613, 614 each request and receive macro hopping and micro hopping schedules from the master scheduler 620. For an embodiment, each base station 611, 612, 613, 614 requests schedules that includes times at which they want resources and the frequency allocation requested.

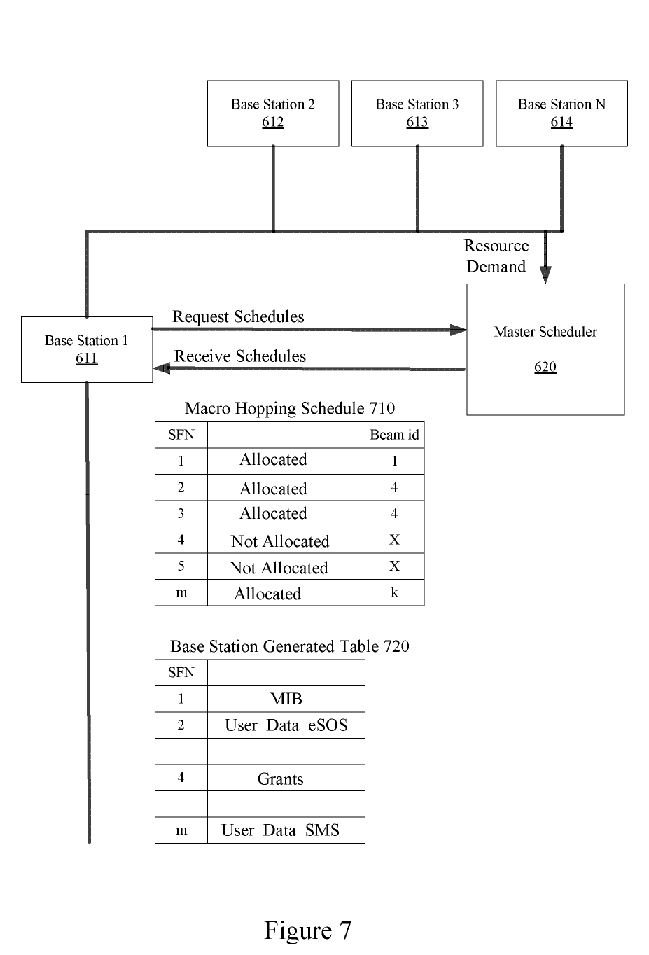

FIG. 7 is a block diagram of a satellite base station 611 requesting and receiving a macro hopping schedule and a micro hopping schedule from a master scheduler 620, according to an embodiment. As shown, the multiple satellite base stations 611, 612, 613, 614 are all competing for wireless satellite signal resources which are allocated by the master scheduler 620. The master scheduler 620 provides the satellite base station 611 with the macro hopping schedule 710 and a micro hopping schedule. The satellite base station 611 then generates a table 720 that includes allocations of subframe numbers (SFNs). All the satellite base stations 611, 612, 613, 614 generate scheduling tables, such as, schedulin 720 that include allocations of subframe numbers (SFNs) and message types which is intended to be sent during those subframes.

For an embodiment, the master scheduler 620 is configured to examine the upcoming time windows (that is, time slots a few milliseconds in advance) to decide which beams (and corresponding satellite base stations) will be activated per the macro and micro beam hopping schedules. For an embodiment, the examination and scheduling are based on real-time demand (including how many user (wireless device) messages or queued for delivery), priority (that is, for example, sSOS messages have higher priority than IP-based messages or data), and/or historical usage (that is, if certain messages were deferred previously, they might be prioritized).

For an embodiment, the inputs to the master scheduler include message periodicity and repetition for broadcast messages. For example, MIB or SIB1 broadcast messages might have a certain scheduling period and a nominal repetition. For an embodiment, the satellite system reduces these repetitions to lower duty cycles.

At least some embodiments include adaptive repetition rates for the broadcast messages. For an embodiment, the adaptive repetition rates are based on an adaptive function (adaptive_rep (ch_utilization (channel utilization))) that dynamically adjusts how many times a message is repeated, depending on channel load and link quality. This may include fewer repetitions in good conditions or light load, or more repetitions under bad RF (radio frequency) conditions or high load.

As described, at least some embodiments include consideration of data (message) priority. For an embodiment, this includes for user (wireless device) traffic (for example, eSOS, SMS (small message system), NIDD, IP), a priority function (user_data) that determines QoS class and how urgently the messages should be served. For an embodiment, eSOS may be the higher priority traffic, while IP traffic may be the lowest priority.

Further, as described, at least some embodiments utilize message history. For an embodiment, the message history includes a function history (message_type, rejection history) which tracks whether certain message types (for example, SIB updates, user data) have been delayed before. For an embodiment, this ensures fairness to avoid indefinite postponement of lower-priority data.

For an embodiment, master scheduler logic includes a prioritization step. For an embodiment, the prioritization step includes the master scheduler ranking requests from each satellite base station according to highest-priority user (wireless device) data first (for example, eSOS), critical system broadcasts (for example, MIB or SIB changes), requests with prior delays or rejections so that the requests or in a queue.

For an embodiment, master scheduler logic includes a resource allocation step. For an embodiment, the resource allocation step includes the master scheduler identifying which satellite base stations to activate in the upcoming 1-ms frame (this number can be scaled or tuned) and ensuring that the total number of active channels system-wide does not exceed the maximum allowed for the satellite.

For an embodiment, the master scheduler includes adaptive repetition and periodicity management. For an embodiment, the master scheduler continuously tracks channel loads (ch_utilization). For an embodiment, if the load is low or communication (wireless) signals are strong, the master scheduler may reduce repetition counts (nrep). For an embodiment, if the load is high or conditions degrade, the master scheduler may temporarily increase the repetition count to ensure message reliability.

At least some embodiments include reducing the duty cycle. That is, by reducing the repetition counts (for example, MIB from 10% to 2.5%, SIB1 from 2.5% to 0.3125%, etc.), the sum of all broadcast duty cycles can be reduced. Further, beam-hopping with concurrency limits (for example, 20 total active channels) ensures not all beams are active at once further preventing an excessive duty cycle across multiple beams.

At least some embodiments include per satellite base station control of the satellite network. As described, the macro hopping and micro hopping schedule provide time slots for scheduled communication of each satellite base station of the satellite network. For an embodiment, the scheduling includes broadcast transmissions, user (wireless device) data transmissions, a reporting.

For an embodiment, the satellite base station transmits (broadcasts) MIB, SIB, or other system broadcasts with the specified repetition which may be adaptively lowered. For an embodiment, the broadcasts are timed such that every beam gets them in the same or shorter intervals.

For an embodiment, the satellite base station transmits user (wireless device) data in priority order (for example, eSOS first, then other traffic), respecting the QoS requirements.

For an embodiment, the satellite base station periodically reports status (for example, current demand, link quality) back to the master scheduler. For an embodiment, this feedback allows the master scheduler to fine-tune future repetition rates and beam usage.

For an embodiment, the master scheduler maintains a history of message rejections or delays. For an embodiment, if certain traffic (for example, lower-priority IP) was previously postponed, it receives higher consideration in the next cycle to prevent it from being starved indefinitely. High- priority services (like emergency SOS) always jump to the front of the queue. By combining this priority scheme with adaptive repetition and beam hopping, the system meets stringent QoS constraints (reliability and delay bounds) while keeping the overall duty cycle low.

For an embodiment, the satellite base station uses digital beamforming to serve multiple beams. For an embodiment, the master scheduler operates on short (1-ms) timescales and plans which beams and satellite base stations go active in upcoming frames. This ensures a concurrency limit (for example, no more than 20 channels active) is maintained and fairness and Quality of Service (QoS) are maintained,

Although specific embodiments have been described and illustrated, the embodiments are not to be limited to the specific forms or arrangements of parts so described and illustrated. The embodiments described are to only be limited by the claims.

What is claimed:

1. A method for controlling beam-hopping of a satellite base station of a satellite network across a plurality of cells the method comprising:
determining, by the satellite network, a macro hopping schedule, wherein the macro hopping schedule includes at least frequency and time slots that control frequency and time allocations for one or more beams of satellites of the satellite network directed to the plurality of cells;
determining, by the satellite network, a micro hopping schedule, wherein timeslots of the micro hopping schedule have a shorter time duration than the timeslots of the macro hopping schedule, wherein the determination of the micro hopping schedule is dependent on the real time traffic demand;
dynamically adjusting, by the satellite base station, frequency and time allocations of the macro hopping schedule and the micro hopping schedule for high traffic and low traffic beams comprising reallocating underutilized time slots of the micro hopping schedules from the lower traffic beams to the higher traffic beams, wherein the lower traffic beams have a lower demand for wireless data traffic than high traffic beams;
wirelessly communicating, by the satellite base station, with wireless devices located within cell areas of the plurality of cells according to the dynamically adjusted frequency and time allocations of the macro hopping schedule and the micro hopping schedule.

2. The method of claim 1, wherein the macro hopping schedules for each of the beams are predefined based on a broadcast signal periodicity.

3. The method of claim 1, further comprising dynamically adjusting time and frequency allocated to different beams comprising reallocating time slots of micro hopping schedules from beams that are underutilized to beams that are more utilized.

4. The method of claim 1, wherein the satellite base station is defined by cell identifiers of the plurality of cells over a fixed geographical area, wherein the satellite base station is at a fixed location for an earth satellite base station, and wherein the satellite base station changes satellite locations over time for a satellite based base station.

5. The method of claim 1, wherein the satellite base station receives the macro hopping schedule and the micro hopping schedule from a master scheduler, wherein the master schedule is located at one or more of multiple locations of the satellite network.

6. The method of claim 1, wherein a time duration of the time slots of the macro hopping schedule is long enough that wireless devices receiving beams do not go into a radio link failure state when beams hop from one cell to another cell.

7. The method of claim 1, wherein a time duration of the time slots of the macro hopping schedule is selected based on message periodicity and repetition of broadcast messages sent to wireless devices located within a coverage area of the plurality of geographical cells.

8. The method of claim 1, wherein a time duration of the time slots of the macro hopping schedule is more than a radio link failure (RLF) detection timer (T310) configured on a wireless device that communicates with the satellite network.

9. The method of claim 1, wherein the determination of the micro hopping schedule is further dependent on a message priority of messages being communicated to wireless devices located within the plurality of fixed geographical cells.

10. The method of claim 1, further comprising determining the real-time traffic demand based on buffer status reports.

11. The method of claim 1, wherein an allocated active time duration allocated to each beam is initially set by the duration of the timeslots of the macro hopping schedule and subsequently adjusted by underutilized timeslots of the micro hopping schedules of other beams.

12. The method of claim 1, further comprising:
determining by the satellite master scheduler a history function that represents deferred messages for all wireless devices and all base stations serving all the cells in a particular area, wherein the particular area is defined by the plurality of geographical cells; and
reallocating underutilized time slots of the micro hopping schedules from the lower traffic beams to the higher traffic beams based on the history function;
wherein previously deferred messages tracked by the history function include lower-priority traffic, and wherein elevating a service priority prevents the lower-priority traffic from being indefinitely postponed.

13. The method of claim 1, further comprising determining a real-time traffic demand based on receiving a traffic indication with a predetermined set of Random Access Preamble (Msg1) transmission from a wireless device within a coverage area of at least one of the plurality of cells, wherein the traffic indication is included within a Msg1 provides immediate demand knowledge to a Master Scheduler by avoiding a delay of at least two Round-Trip Times (RTTs) that would be incurred if the traffic indication were transmitted via an uplink scheduled transmission (Msg3).

14. The method of claim 1, further comprising employing an adaptive repetition function o dynamically adjust a repetition countof critical system broadcasts, including Master Information Block (MIB) and System Information Block (SIBs transmissions, based on channel utilization, thereby adjusting available resources for wireless device data transmission by adjusting (increase/decrease) the broadcast duty cycle, wherein the broadcast duty cycle defines a relation between a time where the broadcast is on/active versus all other available time that the broadcast can be transmitted.

15. The method of claim 1, wherein executing the Macro-Hopping schedule includes configuring a coverage pulse to be long enough for the wireless device to obtain its RRC connection.

16. The method of claim 1, wherein the one or more beams include wide beams or narrow beams, wherein a selection of beam size is based on a type of message being transmitted by the satellite base station.

17. The method of claim 1, wherein the lower traffic beams and the high traffic beams are determined based on PRACH (MSG1) traffic received in different beams.

18. The method of claim 1, further comprising initiating a fast scan mode based on at least one of an initialization of the satellite base station, a periodic initiation, or initiation based on sensing a level of traffic disparity, wherein the fast scan mode comprises:
performing, by the satellite base station, beam hopping across an entire coverage area of the plurality of cells to detect and assess traffic activity in each cell of the plurality of cells; and
cyclically activating, by the satellite base station, all beams of interest at regular intervals, enabling PRACH (Physical Random Access Channel) opportunities for wireless devices located in every cell;
wherein the fast scan mode serves as a discovery and monitoring phase to identify where active uplink requests or connection attempts are occurring.

19. The method of claim 1, further comprising:
transmitting, by the satellite base station, to a wireless device, a Random Access Response (RAR) message comprising a first field indicating a transmission deferral requirement and a second field indicating a time offset; and
deferring, by the wireless device, a Radio Resource Control (RRC) Connection Request message (Msg3) when receiving instructions from the first field and the second field within the RAR.

20. The method of claim 1, further comprising:
broadcasting, by the satellite base station, system signaling, the system signaling including the macro hopping schedule, for a serving cell of the plurality of cells, and a macro hopping schedule of one or more neighboring cells;
facilitating a mobility procedure for a wireless device based on the system signaling, wherein the mobility procedure comprises:
informing a wireless device about information about beams of surrounding cells including when the beams of the surrounding cells will be available and when a current beam of the serving cell will be unavailable; and
allowing the wireless device to trigger and handover to another cell, and adapting grant requests for sending data based on the information.

21. The method of claim 1, further comprising:
configuring, on a wireless device, an extended radio link timer having a duration exceeding a standard T310 timer duration;
monitoring, by the wireless device, a radio link between the satellite base station and the wireless device; and
providing, by the wireless device, additional tolerance before triggering a Radio Link Failure (RLF) based on the extended radio link timer.

22. A satellite network, comprising;
a master scheduler configured to:
determine a macro hopping schedule, wherein the macro hopping schedule includes at least frequency and time slots that control frequency and time allocations for one or more beams of satellites of the satellite network directed to the plurality of cells; and
determine a micro hopping schedule, wherein timeslots of the micro hopping schedule have a shorter time duration than the timeslots of the macro hopping schedule, wherein the determination of the micro hopping schedule is dependent on the real time traffic demand;
a satellite base station configured to:
dynamically adjust frequency and time allocations of the macro hopping schedule and the micro hopping schedule for high traffic and low traffic beams comprising reallocating underutilized time slots of the micro hopping schedules from the lower traffic beams to the higher traffic beams, wherein the lower traffic beams have a lower demand for wireless data traffic than high traffic beams; and
wirelessly communicate with wireless devices located within cell areas of the plurality of cells according to the dynamically adjusted frequency and time allocations of the macro hopping schedule and the micro hopping schedule.
